(19) United States
(12) Patent Application Publication
(10) Pub. No.: US 2019/0248473 A1
(43) Pub. Date: Aug. 15, 2019

(54) ACTIVE WING TIPS FOR TILTROTOR WHIRL FLUTTER STABILITY AUGMENTATION

(71) Applicant: U.S. Army Research Laboratory ATTN: RDRL-LOC-I, Adelphi, MD (US)

(72) Inventors: Hao Kang, Abingdon, MD (US); Matthew W. Floros, Bel Air, MD (US)

(21) Appl. No.: 15/895,189

(22) Filed: Feb. 13, 2018

(51) Int. Cl. B64C 13/18; B64C 29/00; B64D 45/00

(52) U.S. Cl. CPC B64C 13/18; B64D 2045/0085; B64D 45/00; B64C 29/0033

(57) ABSTRACT

Mitigating whirl flutter in a tiltrotor aircraft includes providing at least one control surface supported for movement relative to a pylon attached to the aircraft's wing; providing an actuator for moving the control surface relative to the pylon; providing at least one sensor system to sense at least one deformation mode of the wing tip; providing a control system having one or more inputs and one or more output signals; using an electrical signal relating to deformation of the wing tip to serve at least as the basis for at least one of the inputs to the control system; determining at least one output signal of the control system based at least in part on the electrical signal relating to deformation; and controlling the actuator based at least in part on the output signal of the control system to move the control surface so as to counteract the deformation.

### GOVERNMENT INTEREST

The embodiments described herein may be manufactured, used, and/or licensed by or for the United States Government without the payment of royalties thereon.

### BACKGROUND

### Technical Field

The embodiments herein generally relate to the mitigation of whirl flutter in tiltrotor air craft, and more particularly to an active control surface provided outboard of the wing pylon for the mitigation of whirl flutter.

### Description of the Related Art

The tilt rotor has been a solution for high speed vertical lift which provides a dramatic increase in range and speed while retaining vertical lift capability of traditional edgewise rotor helicopters. Because a tilt rotor requires sufficient power to lift the aircraft vertically it normally has ample power available for high speed cruise. Its maximum speed is limited directly or indirectly by proprotor stability, known as whirl flutter. The flutter boundary limits the maximum speed, hut also limits range because the high wing stiffness required to mitigate flutter requires thick wing sections which are less efficient for high speed flight. Whirl flutter has been researched by NASA and the Department of Defense since the 1960's.

Starting in the 1990's, the U.S. Army and NASA conducted tests on a scale model based on the V-22 Osprey. Effects of rotor and control parameters have been investigated, including the baseline 3 bladed gimbaled hub and a soft in-plane 4-bladed semi-articulated hub with variations such as pitch flap coupling from the blade's “δ₃” pitch-flap coupling angle.

Recently, control system modifications were investigated to address whirl flutter stability. A novel “stepover” control system configuration was implemented to achieve the desired negative 63 in a 4-bladed gimbaled rotor without interfering with adjacent blades. The stepover configuration effectively provides approximately −15 deg of δ₃ without requiring the actual 83 angle. Stability test results showed that the stepover mechanism provides as much or more stability to the 4-bladed rotor as the conventional control system provided for the 3-bladed rotor, at the expense of additional mechanical complexity.

An active approach using generalized predictive control (GPC) in the swashplate was also investigated. The GPC-based active control system was found to be highly effective in increasing the damping of the critical wing beam mode without visible degradation of the damping in the other modes over the range of the conditions investigated. The GPC active stability control algorithm was also shown to significantly increase the sub-critical damping of the 4-bladed aeroelastic model with the stepover control system installed.

Structural tailoring of the wing for the aeroelastic stability augmentation was examined as well. The wing torque box was modified by using unbalanced composite laminates to introduce wing bending-torsion coupling. Wind tunnel tests demonstrated that the proprotor aeroelastic stability boundary could be increased by 30 knots using composite tailoring in the wing. Alternatively, for the same stability boundary, introducing bending-torsion coupling in the wing allowed the wing thickness to be reduced for increased aerodynamic efficiency.

Optimizing the blade design for improved stability was investigated using an analytical model of the XV 15 research aircraft. A thinner, composite wing was designed to be representative of a high-speed tiltrotor. It was found that rearward offsets of the aerodynamic-center locus with respect to the blade elastic axis created large increases in the stability boundary. The effect was strongest for offsets at the outboard part of the blade, where an offset of the aerodynamic center by 10% of tip chord improved the stability margin by over 100 knots. Forward offsets of the blade center of gravity had similar but less pronounced effects. Equivalent results were seen for swept tip blades. An appropriate combination of sweep and pitch stiffness completely eliminated whirl flutter within the speed range examined. Alternatively, it allowed large increases in pitch-flap coupling (δ₃) for a given stability margin.

Elastic wing extensions and winglets were also shown to improve whirl flutter stability. A wing extension could improve the stability boundaries of the wing beam and torsion modes by 70 knots and 80 knots, respectively. A winglet with a low cant angle could improve the wing beam and torsion mode stability boundaries also.

Wing extensions and winglets were further studied in an optimization framework to simultaneously augment damping and maximize aircraft aerodynamic efficiency while minimizing weight penalty. Parametric studies showed that a wing extension with a span of 25% of the inboard wing increases the whirl flutter speed by 10% and also increases the aircraft aerodynamic efficiency by 8%. Structurally tapering the wing of a tiltrotor equipped with an extension and a winglet may increase the whirl flutter speed by 15% while reducing the wing weight by 7.5%.

An investigation of active control of wing flaperons for stability augmentation has also been conducted. Both stiff in-plane and soft in-plane tiltrotor configurations were examined. The flaperon was shown to be particularly effective for increasing wing vertical bending mode damping.

Whirl flutter stabilization using an active blade trailing edge was investigated. The controller concept explicitly uses the periodicity of rotor systems. By applying a rotational matrix for periodic properties of rotating systems, the whirling motion of the instability is shifted in phase and reinjected into the system to stabilize the whirl flutter. It showed in simulation that whirl flutter may be alleviated by the control approach.

The previously proposed solutions have not been satisfactory from an implementation standpoint. Many require exotic materials and rely on untried and untested technologies. Elastically coupled wings require qualification of the unbalanced laminates, increasing development costs. Any active rotor system must account for centrifugal loads, transmitting power and data signals to the rotating frame, higher actuator count (per blade rather than per wing), and other additional complexity. The previously proposed solutions have a high cost and present a high risk of failure. Furthermore, they would be difficult if not impossible to retrofit to existing aircraft.

### SUMMARY

In view of the foregoing, an embodiment herein provides a method for mitigating whirl flutter in a tiltrotor aircraft having at least one wing, at least one proprotor supported by a pylon attached to the wing, the wing having a root and a wing tip, the method comprising providing at least one control surface supported for movement relative to the pylon; providing an actuator for moving the control surface relative to the pylon; providing at least one sensor system to sense at least one deformation mode of the wing tip, the sensor system allowing the generation of an electrical signal relating to deformation in a deformation mode of the wing; providing a control system having one or more inputs and one or more output signals; using the electrical signal relating to deformation of the wing tip to serve at least as the basis for at least one of the inputs to the control system; determining at least one output signal of the control system based at least in part on the electrical signal relating to deformation; and controlling the actuator based at least in part on the at least one output signal of the control system to move the control surface so as to counteract the deformation.

The control surface may be pivotally supported for pivotal movement relative to the pylon and the control surface is moved pivotally. The deformation mode may comprise a beamwise mode deformation, which corresponds to movement of the wing tip approximately perpendicular to the wing chord at the wing tip. The deformation mode may comprise a chordwise mode deformation, which corresponds to movement of the wing tip approximately parallel to the wing chord at the wing tip. The deformation mode may comprise a torsion mode deformation, which corresponds to twisting movement of the wing tip that changes an angle defined by the wing root chord and the wing tip chord. The control surface may be provided by an all moving airfoil section that is pivotally supported by the pylon. The method may extend the baseline stability boundary of the aircraft by an amount in the range of about ¼ to about ⅓ of the baseline stability boundary.

Another embodiment provides a system for mitigating whirl flutter in a tiltrotor aircraft having at least one wing, at least one proprotor supported by a pylon attached to the wing, the wing having a root and a wing tip, the system comprising at least one control surface supported for movement relative to the pylon; an actuator for moving the control surface relative to the pylon; a control system having one or more inputs and one or more output signals, the control system receiving at least one of the inputs from at least one sensor system, directly or upon further processing, for sensing at least one deformation mode of the wing, the sensor system allowing the generation of an electrical signal relating to motion of the wing tip in the deformation mode of the wing, which provides the at least one of the inputs to the control system; and the control system being configured to produce at least one output signal based at least in part on the electrical signal relating to wing tip motion, wherein the actuator moves the control surface so as to counteract the wing tip motion based at least in part on the at least one output signal of the control system. The control surface may be pivotally supported for pivotal movement relative to the pylon and the control surface is moved pivotally. The deformation mode may comprise a beamwise mode deformation, which corresponds to movement of the wing tip approximately perpendicular to the wing chord at the wing tip.

The sensor system may include a first sensor sub-system for sensing the motion of the wing tip at least in a direction corresponding to the deformation mode, the first sensor sub-system generating a signal relating to the motion of the wing tip at least in the direction corresponding to the deformation mode, and a second sensor sub-system for sensing the rigid body motion of the wing root at least in a direction corresponding to the deformation mode, the second sensor sub-system generating a signal relating to the rigid body motion of the wing root at least in the direction corresponding to the deformation mode, and wherein the system further comprises a subtractor configured to correct the signal from the first sensor sub-system by the signal from the second sensor sub-system to generate the electrical signal relating to deformation in the deformation mode.

The deformation mode may comprise a chordwise mode deformation, which corresponds to movement of the wing tip approximately parallel to the wing chord at the wing tip. The deformation mode may comprise a torsion mode deformation, which corresponds to twisting movement of the wing tip that changes an angle defined by the wing root chord and the wing tip chord. The deformation mode may comprise deformation in a beamwise mode, wherein the at least one sensor system is configured to sense motion of the wing tip in at least the beamwise mode and a chordwise mode of the wing, the sensor system allowing the generation of a first electrical signal relating to motion of the wing tip in the beamwise mode of the wing and of a second electrical signal relating to motion of the wing tip in the chordwise mode of the wing, wherein the control system is configured to receive the first electrical signal and the second electrical signal as the inputs to the control system, wherein the control system is configured to generate at least one output signal based at least in part on the first electrical signal and the second electrical signal, and wherein the actuator moves the control surface so as to counteract the motion of the wing tip in at least one of the beamwise and chordwise modes based at least in part on the at least one output signal of the control system.

The sensor system may include a first sensor sub-system for sensing the motion of the wing tip at least in beamwise and chordwise directions corresponding to the beamwise and chordwise modes of deformation, the first sensor sub-system generating signals relating to the motion of the wing tip at least in the beamwise and chordwise directions, respectively, and a second sensor sub-system for sensing the rigid body motion of the wing root at least in the beamwise and chordwise directions, the second sensor sub-system generating signals relating to the rigid body motion of the wing root at least in the beamwise and chordwise directions, respectively, wherein the system further comprises a first subtractor configured to correct the signal from the first sensor sub-system relating to deformation in the beamwise mode by the signal from the second sensor sub-system relating to the beamwise rigid body motion of the wing root to generate the first electrical signal, and wherein the system further comprises a second subtractor configured to correct the signal from the first sensor sub-system relating to deformation in the chordwise mode by the signal from the second sensor sub-system relating to the chordwise rigid body motion of the wing root to generate the second electrical signal.

The deformation mode may comprise deformation in a beamwise mode, wherein the at least one sensor system is configured to sense deformation in at least the beamwise mode, a chordwise mode, and a torsion mode of the wing, the sensor system allowing the generation of a first electrical signal relating to deformation in the beamwise mode of the wing, of a second electrical signal relating to deformation in the chordwise mode of the wing, and of a third electrical signal relating to deformation in the torsion mode of the wing, wherein the control system is configured to receive the first electrical signal, the second electrical signal, and the third electrical signal as the inputs to the control system, wherein the control system is configured to generate at least one output signal based at least in part on the first electrical signal, the second electrical signal, and the third electrical signal, and wherein the actuator moves the control surface so as to counteract the motion of the wing tip in at least one of the beamwise, chordwise, and torsion modes based at least in part on the at least one output signal of the control system.

The sensor system may include a first sensor sub-system for sensing the motion of the wing tip at least in beamwise, chordwise, and torsion directions corresponding to the beamwise, chordwise, and torsion modes of the deformation, the first sensor sub-system generating signals relating to the motion of the wing tip at least in the beamwise, chordwise, and torsion directions, respectively, and a second sensor sub-system for sensing the rigid body motion of the wing root at least in the beamwise, chordwise, and torsion directions, the second sensor sub-system generating signals relating to the rigid body motion of the wing root at least in the beamwise, chordwise, and torsion directions, respectively, wherein the system further comprises a first subtractor configured to correct the signal from the first sensor sub-system relating to motion of the wing tip in the beamwise mode by the signal from the second sensor sub-system relating to the beamwise rigid body motion of the wing root to generate the first electrical signal, wherein the system further comprises a second subtractor configured to correct the signal from the first sensor sub-system relating to deformation in the chordwise mode by the signal from the second sensor sub-system relating to the chordwise rigid body motion of the wing root to generate the second electrical signal, and wherein the system further comprises a third subtractor configured to correct the signal from the first sensor sub-system relating to motion of the wing tip in the torsion mode by the signal from the second sensor sub-system relating to the rigid body motion of the wing root in the torsion direction to generate the third electrical signal.

The control system may comprise a first integrator that receives the first signal and produces an output that serves as an input to a first PID controller, an output of the first PID controller serves as an input to a first transfer function of the first order that produces an output, which is then amplified with a first gain to produce a first mode based output signal; a second integrator that receives the second signal and produces an output that serves as an input to a second PID controller, an output of the second PID controller serves as an input to a second transfer function of the first order that produces an output, which is then amplified with a second gain to produce a second mode based output signal; and a third PID controller, wherein the third signal corresponds to or is processed to correspond to an angular velocity of the torsion mode deformation, which provides an input to the third PID controller, an output of the third PID controller serves as an input to a third transfer function of the first order that produces an output, which is then amplified with a third gain to produce a third mode based output signal, wherein the control system is adapted to sum the first mode based output signal, the second mode based output signal, and the third mode based output signal to produce the at least one output signal of the control system. The control surface may be provided by an all moving airfoil section that is pivotally supported by the pylon. The airfoil section may be controlled to move pivotally corresponding to the wing tip chord line in the absence of flutter.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a perspective view of a model of a wing and proprotor of a tiltrotor aircraft showing attachment of an active control surface, according to an embodiment herein;

FIG. 2 is a schematic control system diagram illustrating a flutter mitigation system for a tiltrotor aircraft, according to an embodiment herein;

FIG. 3 is a schematic diagram illustrating the motions which are provided as inputs to the control system, according to an embodiment herein; and

FIG. 4 is a flow diagram illustrating a method of flutter mitigation for a tiltrotor aircraft, according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

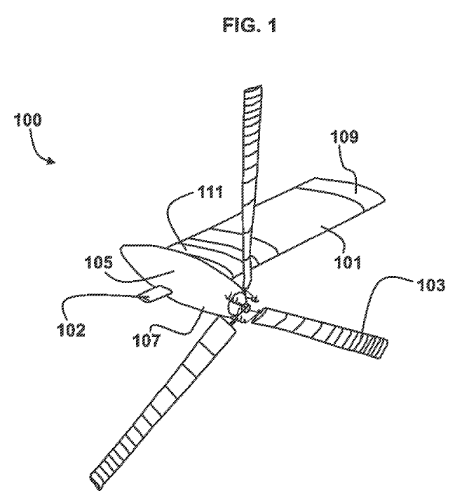

The embodiments herein provide a system and method for mitigating whirl flutter in a tiltrotor aircraft. Referring now to the drawings, and more particularly to FIGS. 1 through 4, there are shown exemplary embodiments.

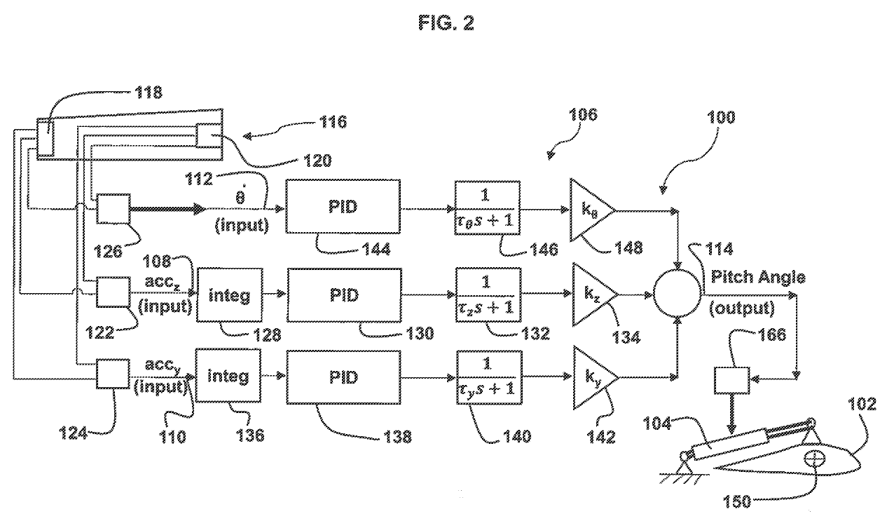

An exemplary system 100 for mitigating whirl flutter in a tiltrotor aircraft may be seen in FIGS. 1 through 4. In FIG. 1, a tiltrotor aircraft has at least one wing 101 and at least one proprotor 103 supported by a pylon 105 that is integrated into the nacelle 107 attached to the wing. The wing 101 has a root 109, and a tip 111. The system 100 includes at least one control surface embodied as an airfoil section 102 supported for movement relative to the pylon 105. The airfoil section 102 is provided outboard of the pylon 105. The illustrative system 100 also includes an actuator 104, shown in FIG. 2, positioned in the nacelle 107 for moving the control surface relative to the pylon 105.

As shown in FIG. 2, the illustrative system 100 further includes a control system 106 having one or more inputs 108, 110, and 112 and one or more output signals 114. The control system 106 receives at least one of the inputs 108, 110, and 112 from at least one sensor system 116, directly or upon further processing, for sensing at least one deformation of the wing 101. The sensor system 116 allows the generation of an electrical signal relating to deformation in the particular deformation mode of the wing 101, which provides at least one of the inputs 108, 110, and 112 to the control system 106.

The at least one sensor system 116 measures the motion of the wing tip 111, which includes both elastic deformation of the wing 101 and the rigid body motion of the aircraft. Subtracting out the information from the root sensors eliminates the rigid body motion, leaving elastic deformation of the wing 101. “Flutter” occurs above a threshold speed when those elastic deformations become unstable. The active wing tip 111 cancels the tip “deformations,” at all airspeeds, which increases the airspeed at which flutter will occur.

The control system 106 is configured to produce at least one output signal 114 based at least in part on the electrical signal 108, 110, or 112 relating to deformation. The actuator 104 moves the airfoil section 102 so as to counteract the deformation based at least in part on the at least one output signal 114 of the control system. In the illustrative example system 100, the airfoil section 102 is pivotally supported for pivotal movement relative to the pylon 105, and the airfoil section 102 is moved pivotally by the actuator 104.

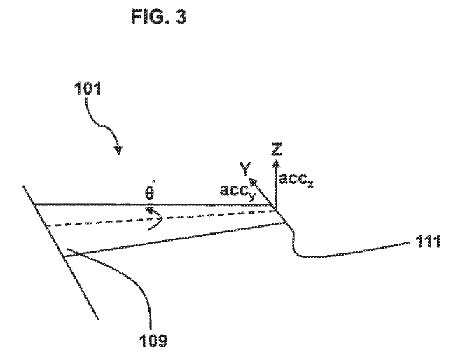

The deformation being sensed and counteracted by the system 100 may, for example, be the beamwise mode deformation, which corresponds to movement of the wing tip 111 approximately perpendicular to the wing chord at the wing tip 1. This is designated as direction Z in FIG. 3. The beamwise direction is also known as the roll direction and corresponds to up and down deformation of the wing tip when the aircraft is level.

The sensor system 116 may, for example, include a first sensor sub-system 118 for sensing the motion of the wing tip 111 at least in the direction corresponding to the chosen deformation. The first sensor sub-system 118 may include one or more linear accelerometers such as disclosed in U.S. Pat. No. 3,734,432, which is incorporated herein by reference in its entirety. Alternatively, one or more motion sensors using microelectromechanical gyroscopes or laser gyroscopes or any other known suitable motion sensor may be used with the embodiments described herein. The first sensor sub-system 118 generates a signal relating to the motion of the wingtip 111 at least in the direction corresponding to the chosen deformation. In the illustrated example, the signal generated by the first sensor sub-system may correspond to the overall beamwise acceleration acc_{Z}, the overall chordwise acceleration acc_{Y}, or the overall angular velocity é for the wing tip 111.

The sensor system 116 may, for example, also include a second sensor sub-system 120 for sensing the motion of the wing root 109 at least in the direction corresponding to the chosen deformation. The second sensor sub-system 120 may include the same types of motion sensors previously described in reference to the first sensor sub-system 118. The second sensor sub-system 120 senses the rigid body motion of the wing root 109 at least in a direction corresponding to the chosen deformation. The second sensor sub-system 120 generates a signal relating to the rigid body motion of the wing root 109 at least in the direction corresponding to the chosen deformation. The system 100 may, for example, further include a subtractor 122 configured to correct the signal from the first sensor sub-system 118 by the signal from the second sensor sub-system 120, by subtracting the signal from the second sensor sub-system 120 from the signal from the first sensor sub-system 118, to generate the electrical signal relating to deformation in the chosen deformation mode and used as the input to the control system 106. In the illustrated example, the corrected signal generated by the sensor sub-system 118 may correspond to the beamwise acceleration acc_{Z}, the chordwise acceleration acc_{Y}, or the angular velocity é of the wing tip 11l leading to deformation as shown in FIGS. 2 and 3. In the illustrated example, the subtractor 122 is grouped with the sensor system 116 for convenience.

In addition, or as an alternative, to the beamwise deformation mode, other deformation modes may be chosen for mitigation by the embodiments such as the system 100. For example, the system 100 may be used to mitigate or stabilize the chordwise mode deformation, which corresponds to movement of the wing tip 11 approximately parallel to the wing chord at the wing tip 111. This is designated as direction Y in FIG. 3. The chordwise direction is also known as the yaw direction and corresponds to fore and aft deformation of the wing tip 111 in relation to the aircraft fuselage.

As another example, the system 100 may be used to mitigate or stabilize the torsion mode deformation, which corresponds to twisting movement of the wing tip that changes an angle defined by the wing root chord and the wing tip chord. This is designated as direction θ and is represented by its derivative 6 in FIGS. 2 and 3, which is used as one of the inputs 112 to the control system 106. The torsion direction is also known as the pitch direction and corresponds to the up and down movement of the leading edge of the wing tip 111 relative to the trailing edge of the wing tip 111 when the aircraft is in approximately level flight.

As another example, the system 100 may be used to mitigate deformation in a plurality of deformation modes. For example, the deformation modes being mitigated may include deformations in the beamwise mode as well as deformations in the chordwise mode. In this embodiment, the sensor system 116 is configured to sense deformations in at least the beamwise mode and the chordwise mode of the wing. The sensor system 116 allows the generation of a first electrical signal relating to deformation in the beamwise mode of the wing and of a second electrical signal relating to deformation in the chordwise mode of the wing.

In this example, the control system 106 is configured to receive the first electrical signal and the second electrical signal as the inputs. The control system 106 is configured to generate at least one output signal based at least in part on the first electrical signal and the second electrical signal. Subsequently, the actuator 104 moves the airfoil section 102 so as to counteract the deformation in at least one of the beamwise and chordwise modes based at least in part on the at least one output signal of the control system 106 and in turn based on both the first electrical signal and the second electrical signal.

In this example, the sensor system 116 includes a first sensor sub-system 118 for sensing the motion of the wing tip at least in beamwise and chordwise directions corresponding to the beamwise and chordwise modes. The first sensor sub-system 118 generates signals relating to the motion of the wingtip at least in the beamwise and chordwise directions, respectively. The second sensor sub-system 120 senses the rigid body motion of the wing root at least in the beamwise and chordwise directions. The second sensor sub-system 120 generates signals relating to the rigid body motion of the wing root at least in the beamwise and chordwise directions, respectively. The system 100 further comprises a first subtractor 122 configured to correct the signal from the first sensor sub-system 118 relating to deformation in the beamwise mode by the signal from the second sensor sub-system 120 relating to the beamwise rigid body motion of the wing root to generate the first electrical signal, by subtracting the signal from the second sensor sub-system 120 relating to the beamwise rigid body motion of the wing root from the signal from the first sensor sub-system 118 relating to deformation in the beamwise mode. The system 100 further comprises a second subtractor 124 configured to correct the signal from the first sensor sub-system 118 relating to deformation in the chordwise mode by the signal from the second sensor sub-system 120 relating to the chordwise rigid body motion of the wing root to generate the second electrical signal, by subtracting the signal from the second sensor sub-system 120 relating to the chordwise rigid body motion of the wing root from the signal from the first sensor sub-system 118 relating to deformation in the chordwise mode.

As yet another example, the system 100 may monitor all the three deformation modes of beamwise, chordwise and torsion mode deformations and generate its control output in response to all three deformation modes. In this example, all three deformation modes, beamwise, chordwise and torsion modes, are sensed. The sensor system 116 is configured to sense deformation in at least the beamwise mode, the chordwise mode, and the torsion mode of the wing. The sensor system 116 allows the generation of a first electrical signal relating to motion in the beamwise mode of the wing, a second electrical signal relating to motion in the chordwise mode of the wing, and a third electrical signal relating to motion in the torsion mode of the wing.

In this example, the control system 106 is configured to receive the first electrical signal, the second electrical signal, and the third electrical signal as the inputs. The control system 106 is configured to generate at least one output signal based at least in part on the first electrical signal, the second electrical signal, and the third electrical signal. Subsequently, the actuator 104 moves the airfoil section 102 so as to counteract the motion in at least one of the beamwise, chordwise, and torsion modes based at least in part on the at least one output signal of the control system 106 and in turn based on the first electrical signal, the second electrical signal, and the third electrical signal.

In this example, the sensor system 116 includes a first sensor sub-system 118 for sensing the motion of the wing tip at least in beamwise, chordwise, and torsion directions corresponding to the beamwise, chordwise, and torsion modes of the deformation. The first sensor sub-system 118 generates signals relating to the motion of the wingtip 111 at least in the beamwise, chordwise, and torsion directions, respectively. The second sensor sub-system 120 senses the rigid body motion of the wing root at least in the beamwise, chordwise, and torsion directions. The second sensor sub-system 120 generates signals relating to the rigid body motion of the wing root 109 at least in the beamwise, chordwise, and torsion directions, respectively. The system 100 further comprises a first subtractor 122 configured to correct the signal from the first sensor sub-system 118 relating to deformation in the beamwise mode by the signal from the second sensor sub-system 120 relating to the beamwise rigid body motion of the wing root 109 to generate the first electrical signal, by subtracting the signal from the second sensor sub-system 120 relating to the beamwise rigid body motion of the wing root 109 from the signal from the first sensor sub-system 118 relating to motion of the tip 111 in the beamwise mode. The system 100 further comprises a second subtractor 124 configured to correct the signal from the first sensor sub-system 118 relating to deformation in the chordwise mode by the signal from the second sensor sub-system 120 relating to the chordwise rigid body motion of the wing root 109 to generate the second electrical signal, by subtracting the signal from the second sensor sub-system 120 relating to the chordwise rigid body motion of the wing root 109 from the signal from the first sensor sub-system 118 relating to motion of the tip 111 in the chordwise mode. The system 100 further comprises a third subtractor 126 configured to correct the signal from the first sensor sub-system 118 relating to deformation in the torsion mode by the signal from the second sensor sub-system 120 relating to the rigid body motion of the wing root 109 in the torsion direction to generate the second electrical signal, by subtracting the signal from the second sensor sub-system 120 relating to the rigid body motion of the wing root 109 in the torsion direction from the signal from the first sensor sub-system 118 relating to motion of the tip 111 in the torsion mode.

An example of the control system 106 may include at least one Proportional-Integral-Derivative (PID) controller 130, 138, 144 and a first order transfer function for each deformation mode and one integrator 128, 136 for each of the beamwise and chordwise deformation modes. The first integrator 128 receives the first signal 108 and produces an output that serves as an input to the first PID controller 130. The output of the first PID controller 130 serves as the input to the first transfer function 132 of the first order that produces an output, which is then amplified with a first gain, using the first amplifier 134, to produce a first mode based output signal that is based on the beamwise mode motion. The first gain is denoted as K_{z}. The first transfer function 132 of the first order has a first time constant denoted by τ_{z}.

The second integrator 136 receives the second signal and produces an output that serves as an input to the second PID controller 138. The output of the second PID controller 138 serves as the input to the second transfer function 140 of the first order that produces an output, which is then amplified with a second gain, using the second amplifier 142, to produce a second mode based output signal that is based on the chordwise mode motion. The second gain is denoted as K_{y}. The second transfer function 140 of the first order has a second time constant denoted by τ_{y}.

The third signal 112 corresponds to or is processed to correspond to an angular velocity of the torsion mode motion, which then serves as an input to the third PID controller 144. The output of the third PID controller 144 serves as the input to the third transfer function 146 of the first order that produces an output, which is then amplified with a third gain, using the third amplifier 148, to produce a third mode based output signal that is based on the torsion mode deformation. The control system 106 is adapted to sum the first mode based output signal, the second mode based output signal, and the third mode based output signal to produce the at least one output signal of the control system 100 that provides a control signal to the actuator 104. The third gain is denoted as K₀. The third transfer function 146 of the first order has a third time constant denoted by re.

In the illustrated example, the airfoil section 102 is pivotally supported by the pylon 105. The airfoil section 102 is provided outboard of the pylon 105. In the illustrated example, the airfoil 102 has a NACA 0012 section. In one example, the airfoil section is controlled to move pivotally in the range of from about −1.5° to about +1.5° about a reference angle corresponding to the wing tip chord line in the absence of deformation. However, the allowable range may be larger than this range and would be limited by either the actuator bandwidth or to avoid stalling the wing tip 111. The chord line of the wing root 109 may also be used as a reference when sensing the rate of change of the wing tip pitch. The airfoil section 102 pivotally moves about a pivot axis 150 that is coincident with both quarter chord line of the airfoil section 102 and the quarter chord line of the wing 101. The airfoil section 102 has a chord that is from about 15% to about 25% of the wing chord, and the airfoil section 102 has a span that is from about 15% to about 25% of the wing span.

The system 100 has shown the potential for extending the baseline stability boundary of the tiltrotor aircraft by an amount in the range of about ¼ to about ½ of the baseline stability boundary. In simulation studies, this has meant an increase in aircraft speed from about 160 knots to about 210 knots.

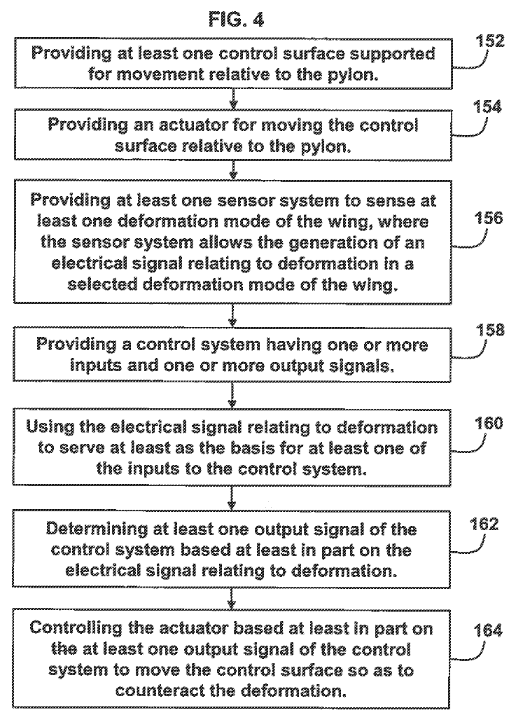

Referring to FIG. 4, an embodiment of the disclosed method may be seen. Block 152 describes providing at least one airfoil section 102 supported for movement relative to the pylon 105. Block 154 describes providing an actuator 104 for moving the airfoil section 102 relative to the pylon 105. Block 156 describes providing at least one sensor system 116 to sense at least one deformation mode of the wing, where the sensor system 116 allows the generation of an electrical signal relating to deformation in a selected deformation mode of the wing. Block 158 describes providing a control system 106 having one or more inputs and one or more output signals. Block 160 describes using the electrical signal relating to deformation to serve at least as the basis for at least one of the inputs to the control system 106. Block 162 describes determining at least one output signal of the control system 106 based at least in part on the electrical signal relating to deformation. Block 164 describes controlling the actuator 104 based at least in part on the at least one output signal of the control system 106 to move the airfoil section 102 so as to counteract the deformation.

Yet another example of the method includes correcting the signal relating to wing tip motion in the beamwise direction from a first sensor sub-system 118 by subtracting a signal relating to the rigid body motion of the wing root 109 in the beamwise direction from a second sensor sub-system 120 to generate a first electrical signal relating to motion of the tip 111 in the in the beamwise mode. Then, using the first electrical signal as the input to the control system 106, determining at least one output signal of the control system 106 based at least in part on the first electrical signal, and controlling the actuator 104 based at least in part on the at least one output signal of the control system 106 to move the control surface 102 so as to counteract the deformation in at least the beamwise modes.

A further example of the method includes correcting the signal relating to wing tip motion in beamwise and chordwise directions from a first sensor sub-system 118 by subtracting a signal relating to the rigid body motion of the wing root 109 in beamwise and chordwise directions from a second sensor sub-system 120 to generate first and second electrical signals relating to motion of the tip 111 in the in beamwise and chordwise modes. Then, using the first electrical signal and the second electrical signal as the inputs to the control system 106, determining at least one output signal of the control system 106 based at least in part on the first electrical signal and the second electrical signal, and controlling the actuator 104 based at least in part on the at least one output signal of the control system 106 to move the control surface 102 so as to counteract the motion of the tip 111 in at least one of the beamwise and chordwise modes.

Yet another example of the method includes correcting the signal relating to wing tip motion in beamwise, chordwise, and torsion directions from a first sensor sub-system 118 by subtracting a signal relating to the rigid body motion of the wing root 109 in beamwise, chordwise, and torsion directions from a second sensor sub-system 120 to generate first, second, and third electrical signals relating to deformation in the in beamwise, chordwise, and torsion modes. Then, using the first electrical signal, the second electrical signal, and the third electrical signal as the inputs to the control system 106, determining at least one output signal of the control system 106 based at least in part on the first electrical signal, the second electrical signal, and the third electrical signal, and controlling the actuator 104 based at least in part on the at least one output signal of the control system 106 to move the control surface 102 so as to counteract the motion of the tip 111 in at least one of the beamwise, chordwise, and torsion modes.

In the illustrated example, a hydraulic actuator 104 for pivotally moving the airfoil 102 is shown. However, any type of actuator known for moving the control surfaces in aircraft, including, without limitation, electric, hydraulic, electromechanical linear actuator, electric motor hydraulic motor, screw jack, and rack and pinion actuators may be used.

In the illustrated example, an all-moving airfoil section 102 is used. However, a wing extension provided outboard of the pylon 105 and having a pivotally moving trailing edge control surface may also be used. The wing extension may also have leading edge as well as trailing edge control surfaces, and the control surfaces may be conformal or deformable rather than pivotable.

Furthermore, more sophisticated control systems may also be used in place of or in addition to the PID controllers 130, 138, 144. These could include transfer functions for the servo-control 166 of the actuator 104, and the feedback loop from the sensors. Also, more sophisticated models of the structural and aerodynamic and aeroelastic behaviors of the airfoil 102 and the aircraft may be incorporated into the control system 106.

Studies carried out by the inventors provided the following results:

For an active tip controlled with only beamwise feedback, the beam mode stability boundary extends to approximately 212 knots vs the baseline of about 160 knots. The active tip also increases the chord mode damping at the speed of 170 knots and higher, stabilizing the chord mode over the entire speed range for time constants of τ_{z}=0.03-0.05 sec. Reducing the time constant increases wing beam mode damping but decreases chordwise damping, making it the limiting mode for stability. Optimum gain for K_{z} was 15-20. The same range applies to K_{y} and K₀.

Increasing wing tip size increased beam and chord damping. There did seem to be a limit where further increases in size would not extend the stability boundary beyond about 215 kts.

For a wing tip controlled with only a chordwise feedback, the wing chord mode damping may be increased by 1-2% at the airspeed of 180 to 250 knots when a time constant of t=0.01 is applied. Chordwise feedback did not improve the beam mode damping to influence the overall stability boundary.

For a wing tip controlled with only a pitch rate feedback, the wing torsion mode damping increases by 3-8% at the airspeed of 150 to 250 knots when a time constant of τ₀=0.01 is applied. However, the wing beam mode damping was reduced by about 1% over the entire speed range addressed, lowering the overall stability boundary. The effects of combining beamwise and chordwise feedback were additive. With individually optimized control system parameters, both types of feedback increased the chordwise damping both separately and together, stabilizing it over the entire speed range. The overall stability boundary was extended from 160 knots in the baseline to about 210 knots with dual feedback. Speeds up to 200 knots could be achieved with a 1-1.5% stability margin in both modes.

Because of the complex interactions between the wing aerodynamics, the blade lag of the proprotor, and the dynamics of the gimbaled proprotor the impact of the presence of the airfoil section 102 and like appendages on the stability of the combined wing-proprotor-airfoil segment could not be predicted based on an understanding or experience with the aeroelastic stability of conventional aircraft.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A method for mitigating whirl flutter in a tiltrotor aircraft having at least one wing, at least one proprotor supported by a pylon attached to the wing, the wing having a root and a wing tip, the method comprising:
providing at least one control surface supported for movement relative to the pylon;
providing an actuator for moving the control surface relative to the pylon;
providing at least one sensor system to sense at least one deformation mode of the wing tip, the sensor system allowing the generation of an electrical signal relating to deformation in a deformation mode of the wing;
providing a control system having one or more inputs and one or more output signals;
using the electrical signal relating to deformation of the wing tip to serve at least as the basis for at least one of the inputs to the control system;
determining at least one output signal of the control system based at least in part on the electrical signal relating to deformation; and
controlling the actuator based at least in part on the at least one output signal of the control system to move the control surface so as to counteract the deformation.

2. The method of claim 1, wherein the control surface is pivotally supported for pivotal movement relative to the pylon and the control surface is moved pivotally.

3. The method of claim 1, wherein the deformation mode comprises a beamwise mode deformation, which corresponds to movement of the wing tip approximately perpendicular to the wing chord at the wing tip.

4. The method of claim 1, wherein the deformation mode comprises a chordwise mode deformation, which corresponds to movement of the wing tip approximately parallel to the wing chord at the wing tip.

5. The method of claim 1, wherein the deformation mode comprises a torsion mode deformation, which corresponds to twisting movement of the wing tip that changes an angle defined by the wing root chord and the wing tip chord.

6. The method of claim 2, wherein the control surface is provided by an all moving airfoil section that is pivotally supported by the pylon.

7. The method of claim 1, wherein the method extends the baseline stability boundary of the aircraft by an amount in the range of about ¼ to about ½ of the baseline stability boundary.

8. A system for mitigating whirl flutter in a tiltrotor aircraft having at least one wing, at least one proprotor supported by a pylon attached to the wing, the wing having a root and a wing tip, the system comprising:
at least one control surface supported for movement relative to the pylon;
an actuator for moving the control surface relative to the pylon;
a control system having one or more inputs and one or more output signals, the control system receiving at least one of the inputs from at least one sensor system, directly or upon further processing, for sensing at least one deformation mode of the wing, the sensor system allowing the generation of an electrical signal relating to motion of the wing tip in the deformation mode of the wing, which provides the at least one of the inputs to the control system; and
the control system being configured to produce at least one output signal based at least in part on the electrical signal relating to wing tip motion,
wherein the actuator moves the control surface so as to counteract the wing tip motion based at least in part on the at least one output signal of the control system.

9. The system of claim 8, wherein the control surface is pivotally supported for pivotal movement relative to the pylon and the control surface is moved pivotally.

10. The system of claim 8, wherein the deformation mode comprises a beamwise mode deformation, which corresponds to movement of the wing tip approximately perpendicular to the wing chord at the wing tip.

11. The system of claim 8, wherein the sensor system includes a first sensor sub-system for sensing the motion of the wing tip at least in a direction corresponding to the deformation mode, the first sensor sub-system generating a signal relating to the motion of the wing tip at least in the direction corresponding to the deformation mode, and a second sensor sub-system for sensing the rigid body motion of the wing root at least in a direction corresponding to the deformation mode, the second sensor sub-system generating a signal relating to the rigid body motion of the wing root at least in the direction corresponding to the deformation mode, and wherein the system further comprises a subtractor configured to correct the signal from the first sensor sub-system by the signal from the second sensor sub-system to generate the electrical signal relating to deformation in the deformation mode.

12. The system of claim 8, wherein the deformation mode comprises a chordwise mode deformation, which corresponds to movement of the wing tip approximately parallel to the wing chord at the wing tip.

13. The system of claim 8, wherein the deformation mode comprises a torsion mode deformation, which corresponds to twisting movement of the wing tip that changes an angle defined by the wing root chord and the wing tip chord.

14. The system of claim 8, wherein the deformation mode comprises deformation in a beamwise mode, wherein the at least one sensor system is configured to sense motion of the wing tip in at least the beamwise mode and a chordwise mode of the wing, the sensor system allowing the generation of a first electrical signal relating to motion of the wing tip in the beamwise mode of the wing and of a second electrical signal relating to motion of the wing tip in the chordwise mode of the wing,
wherein the control system is configured to receive the first electrical signal and the second electrical signal as the inputs to the control system,
wherein the control system is configured to generate at least one output signal based at least in part on the first electrical signal and the second electrical signal, and
wherein the actuator moves the control surface so as to counteract the motion of the wing tip in at least one of the beamwise and chordwise modes based at least in part on the at least one output signal of the control system.

15. The system of claim 14, wherein the sensor system includes a first sensor sub-system for sensing the motion of the wing tip at least in beamwise and chordwise directions corresponding to the beamwise and chordwise modes of deformation, the first sensor sub-system generating signals relating to the motion of the wing tip at least in the beamwise and chordwise directions, respectively, and a second sensor sub-system for sensing the rigid body motion of the wing root at least in the beamwise and chordwise directions, the second sensor sub-system generating signals relating to the rigid body motion of the wing root at least in the beamwise and chordwise directions, respectively, wherein the system further comprises a first subtractor configured to correct the signal from the first sensor sub-system relating to deformation in the beamwise mode by the signal from the second sensor sub-system relating to the beamwise rigid body motion of the wing root to generate the first electrical signal, and wherein the system further comprises a second subtractor configured to correct the signal from the first sensor sub-system relating to deformation in the chordwise mode by the signal from the second sensor sub-system relating to the chordwise rigid body motion of the wing root to generate the second electrical signal.

16. The system of claim 8, wherein the deformation mode comprises deformation in a beamwise mode, wherein the at least one sensor system is configured to sense deformation in at least the beamwise mode, a chordwise mode, and a torsion mode of the wing, the sensor system allowing the generation of a first electrical signal relating to deformation in the beamwise mode of the wing, of a second electrical signal relating to deformation in the chordwise mode of the wing, and of a third electrical signal relating to deformation in the torsion mode of the wing,
wherein the control system is configured to receive the first electrical signal, the second electrical signal, and the third electrical signal as the inputs to the control system,
wherein the control system is configured to generate at least one output signal based at least in part on the first electrical signal, the second electrical signal, and the third electrical signal, and
wherein the actuator moves the control surface so as to counteract the motion of the wing tip in at least one of the beamwise, chordwise, and torsion modes based at least in part on the at least one output signal of the control system.

17. The system of claim 16, wherein the sensor system includes a first sensor sub-system for sensing the motion of the wing tip at least in beamwise, chordwise, and torsion directions corresponding to the beamwise, chordwise, and torsion modes of the deformation, the first sensor sub-system generating signals relating to the motion of the wing tip at least in the beamwise, chordwise, and torsion directions, respectively, and a second sensor sub-system for sensing the rigid body motion of the wing root at least in the beamwise, chordwise, and torsion directions, the second sensor sub-system generating signals relating to the rigid body motion of the wing root at least in the beamwise, chordwise, and torsion directions, respectively, wherein the system further comprises a first subtractor configured to correct the signal from the first sensor sub-system relating to motion of the wing tip in the beamwise mode by the signal from the second sensor sub-system relating to the beamwise rigid body motion of the wing root to generate the first electrical signal, wherein the system further comprises a second subtractor configured to correct the signal from the first sensor sub-system relating to deformation in the chordwise mode by the signal from the second sensor sub-system relating to the chordwise rigid body motion of the wing root to generate the second electrical signal, and wherein the system further comprises a third subtractor configured to correct the signal from the first sensor sub-system relating to motion of the wing tip in the torsion mode by the signal from the second sensor sub-system relating to the rigid body motion of the wing root in the torsion direction to generate the third electrical signal.

18. The system of claim 17, wherein the control system comprises:
a first integrator that receives the first signal and produces an output that serves as an input to a first PID controller, an output of the first PID controller serves as an input to a first transfer function of the first order that produces an output, which is then amplified with a first gain to produce a first mode based output signal;
a second integrator that receives the second signal and produces an output that serves as an input to a second PID controller, an output of the second PID controller serves as an input to a second transfer function of the first order that produces an output, which is then amplified with a second gain to produce a second mode based output signal; and
a third PID controller, wherein the third signal corresponds to or is processed to correspond to an angular velocity of the torsion mode deformation, which provides an input to the third PID controller, an output of the third PID controller serves as an input to a third transfer function of the first order that produces an output, which is then amplified with a third gain to produce a third mode based output signal,
wherein the control system is adapted to sum the first mode based output signal, the second mode based output signal, and the third mode based output signal to produce the at least one output signal of the control system.

19. The system of claim 9, wherein the control surface is provided by an all moving airfoil section that is pivotally supported by the pylon.

20. The system of claim 19, wherein the airfoil section is controlled to move pivotally corresponding to the wing tip chord line in the absence of flutter.
